(19) United States
(12) Patent Application Publication
(10) Pub. No.: US 2004/0173928 A1
(43) Pub. Date: Sep. 9, 2004

(54) Method of forming building materials mostly consisting of magnesium oxide

(76) Inventor: Kun-Hee Suh, Seoul (KR)

Correspondence Address: SHLESINGER, ARKWRIGHT & GARVEY LLP, 3000 South Eads Street, Arlington, VA, 22202, US

(21) Appl. No.: 10/733,770

(22) Filed: Dec. 12, 2003

Related U.S. Application Data
(63) Continuation of application No. PCT/KR02/01106, filed on Jun. 12, 2002.

(30) Foreign Application Priority Data
Jun. 14, 2001 (KR) 2001-33585
Jun. 14, 2001 (KR) 2001-33587
Jul. 3, 2001 (KR) 2001-39561

(51) Int. Cl. B27N 3/02; B27N 3/04; B27N 3/08

(52) U.S. Cl. 264/109; 428/688

(57) ABSTRACT

Method of forming building materials mostly consisting of magnesium oxide. The method comprises the steps of mixing magnesium oxide powder with at least one of vegetable powder, vegetable fiber, mineral powder, and mineral fiber in a predetermined mixing ratio to produce an admixture; adding water to the admixture to produce a wet powdered admixture; inserting the wet powdered admixture into a frame mold assembly of a molding machine consisting of a frame mold and a preheated lower mold and heating and compressing the wet powdered admixture using an upper mold and hardening the admixture; and releasing a resulting product from the molding machine. The method is advantageous in that the building materials have an excellent strength and fire retardant, do not emit a poisonous gas at all during their combustion, and can be inexpensively produced in commercial quantity because the building materials can be produced by an injection and an extrusion molding.

### CROSS-REFERENCE TO RELATED APPLICATIONS

This application is a continuation of application no. PCT/KR02/01106, filed Jun. 12, 2002, which claims priority of Korean application no. 2001-33585, filed Jun. 14, 2001, and application no. PCT/KR02/01106 claims priority of Korean application no. 2001-3587, filed Jun. 14, 2001, and application no. PCT/KR02/01106 claims priority of Korean application no. 2001-39561, filed 3 Jul. 2001, and each of which is incorporated herein by reference.

### FIELD OF THE INVENTION

The present invention relates, in general, to a method of forming building materials mostly consisting of magnesium oxide, in particular, a method of forming building materials mostly consisting of magnesium oxide, in which an admixture mostly consisting of magnesium oxide is rapidly hardened in a molding machine, an injection mold, or an extrusion mold each having a heater, thereby strength of the building materials being improved. The method of the present invention is advantageous in that a bilateral molding and a precision molding of such materials are feasible while the molding processes cannot be accomplished by a conventional method, and a process of forming the building materials is simplified and its processing time is shortened, and so the building materials are inexpensively formed and their productivity is improved.

### BACKGROUND OF THE INVENTION

Generally, a building comprises a frame, and an interior and an exterior finish. Even though differing according to kinds of buildings, as a rule, examples of the frame include a ferroconcrete, an iron frame, a timber, and a brick frame, and examples of the interior and exterior finish include a plaster, a timber, a synthetic resin, and a urethane foam finish.

The frame, and the interior and exterior finish are required to have corrosion resistance, heat resistance, fire retardant, and an insulating property, as well as a strength sufficient to endure weight of the building and an external impact.

The fire retardant of building materials is considered very important, but most of the building materials have a safety problem that they are readily combusted and emit poisonous gases when they are heated to a limit temperature or higher even though they are fire retardant, which causes death by suffocation, and so the buildings consisting of conventional building materials are poor in safety. In particular, synthetic resin products used as building materials have the above disadvantages.

Therefore, many efforts have been made to prevent safety problems occurring in case of fire. For example, restrictions are enforced so as to satisfy building codes. Building materials capable of overcoming the safety problems are the building materials mostly consisting of magnesium oxide.

In the present invention, magnesium oxide is used as a main component in the building materials, and when vegetable powder such as sawdust is added to the magnesium oxide and the resulting admixture is hardened, the resulting building materials have excellent physical properties. Additionally, the magnesium oxide has a lightweight and high strength, and is a noninflammable material, and so the building materials mostly consisting of magnesium oxide overcome safety problems in case of fire and do not emit poisonous gases.

Even though magnesium oxide has various advantages, the building materials mostly consisting of the magnesium oxide has not commercially produced, but experimentally produced in small quantities. The reason is that a production of such building materials is considered difficult by those who skilled in the art.

In other words, a conventional method of forming building materials mostly consisting of magnesium oxide comprises the steps of mixing the magnesium oxide with sawdust, chloride as a hardening agent, and water, inserting the resulting admixture into a mold, transporting the resulting mold to a hardening room maintaining a sufficiently high temperature to harden the admixture for a predetermined period of time, and removing a molded product from the mold, like a method of molding a concrete structure in a mold. Therefore, the conventional method is disadvantageous in that the building materials are molded using many molds through multiple stages, and so excessive labor and personnel expenses are consumed and the productivity of the building materials is reduced. Another disadvantage of the conventional method is that a bilateral molding and a precision molding of the building materials cannot be accomplished in view of characteristics of a hardening process that a kneaded material is molded in a mold.

As described above, even though magnesium oxide has various advantages, the building materials mostly consisting of the magnesium oxide have formed by an inferior molding process mostly depending on labor, and not widely used as building materials owing to a conventional poor method of forming such building materials, but experimentally formed in a small quantity.

The reason is that one's attention is only concentrated to the original purpose of forming the building materials mostly consisting of magnesium oxide, that is to say, the purpose of a reduction in a concrete product weight, and so a fixed idea which the building materials mostly consisting of the magnesium oxide are formed by a molding process, like concrete structure, is widely known in the art. In fact, the fixed idea is considered reasonable because cement is not hardened even though the cement is heated and compressed in a mold after it is mixed with various powders and water. However, the present inventor have make many studies to improve the method of forming building materials mostly consisting of magnesium oxide, resulting in an improved method of forming building materials comprising magnesium oxide instead of cement in a commercial quantity.

During these studies, the present inventor has developed many useful inventions, obtaining the patents, below, and the present invention has been accomplished based on the inventions as described below.

1. Korean Pat. No. 109507: Device for continuously forming building materials and method of forming the same

2. Korean Pat. No. 085731: Device for continuously forming concrete building materials

3. Korean Pat. No. 102883: Device for continuously forming building materials

4. Korean Pat. No. 102884: Device for continuously forming building materials

5. Korean Pat. No. 102885: Device for continuously forming concrete building materials

6. U.S. Pat. No. 5756131: Continuous building materials molding device

7. Japanese Pat. No. 2620057: Continuous building materials molding device

8. Chinese Pat. No. 43518: Continuous building materials molding device

9. Chinese Pat. No. 44712: Continuous building materials molding device

10. Korean Pat. No. 109503: Method of forming concrete PC plank and device for forming the same

11. Japanese Pat. No. 2780874: Method of forming concrete PC plank and device for forming the same

12. Chinese Pat. No. 43642: Method of forming concrete PC plank and device for forming the same

13. Indian Pat. No. 181764: Method of forming concrete PC plank and device for forming the same

14. Australian Pat. No. 687070: Method of forming concrete PC plank and device for forming the same.

### OBJECTS AND SUMMARY OF THE INVENTION

Accordingly, the present invention has been made keeping in mind the above problems occurring in the prior art, and an object of the present invention is to provide a method of forming building materials consisting of noninflammable magnesium oxide with a melting point of 2850° C. as a main component and at least one of vegetable powder, vegetable fiber, mineral powder, and mineral fiber as a side component, in which an admixture of magnesium oxide with vegetable or mineral powder is mixed with water and hardened through a compression molding, an injection molding, or an extrusion molding process, thereby building materials with excellent physical properties and economic efficiency can be produced.

It is another object of the present invention to provide a method of forming building materials consisting of mostly magnesium oxide, which displays an improved productivity by simplifying the method and shortening the time needed to form the building materials, for example, by omitting a transporting process of the admixture to a hardening room of the admixture. Therefore, fewer workers than a conventional method of forming building materials can effectively and rapidly form the building material of the present invention.

Based on the present invention, the above objects can be accomplished by a provision of a method of forming building materials consisting of mostly magnesium oxide, comprising the steps of mixing magnesium oxide powder with at least one of vegetable powder, vegetable fiber, mineral powder, and mineral fiber in a predetermined mixing ratio to produce an admixture; adding water to the admixture to produce a wet powdered admixture; inserting the wet powdered admixture into a concave frame mold assembly consisting of a frame mold and a preheated lower mold, and heating and compressing the wet powdered admixture using a preheated upper mold, and hardening the admixture; and releasing a resulting product from the molding machine.

Further, according to the present invention, provided is a method of forming building materials consisting of mostly magnesium oxide, comprising the steps of mixing magnesium oxide powder with at least one of vegetable powder, vegetable fiber, mineral powder, and mineral fiber to produce an admixture; selectively adding water to the admixture in such an amount that the admixture can be used in an injection molding process to produce a wet admixture such as mortar; inserting the wet admixture from a high pressure nozzle through an inlet of a mold assembly into the mold assembly; hardening such admixture by a heater positioned in each mold; and releasing a resulting product from the mold assembly.

Furthermore, the present invention provides a method of forming building materials consisting of mostly magnesium oxide, comprising the steps of mixing magnesium oxide powder with at least one of vegetable powder, vegetable fiber, mineral powder, and mineral fiber to produce an admixture; selectively adding water to the admixture in such an amount that the admixture can be used in an extrusion molding process to produce a wet admixture; extruding the wet admixture into a desired shape of a product by use of an extruder; and passing a resulting product through a heating device positioned before an outlet of the extruder to harden the resulting product.

### BRIEF DESCRIPTION OF THE DRAWINGS

The above and other objects, features and advantages of the present invention will be more clearly understood from the following detailed description taken in conjunction with the accompanying drawings, in which:

FIGS. 1a to 1c are schematic sectional views illustrating the stepwise operation of a compression mold assembly useful in a method of forming building materials mostly consisting of magnesium oxide according to the present invention;

FIG. 2 is a sectional view of an injection mold assembly useful in the method of forming building materials mostly consisting of magnesium oxide according to the present invention;

FIG. 3 is a sectional view of an extrusion molding machine useful in the method of forming building materials mostly consisting of magnesium oxide according to the present invention; and

FIG. 4 is a fragmentary view taken in the direction of the arrows along the line A-A of FIG. 3.

### DETAILED DESCRIPTION OF THE INVENTION

According to the present invention, building materials of high quality are produced when a particle size of the magnesium oxide powder used as a main component in the present invention is fine.

In addition, vegetable powder used as a side component is selected from the group consisting of waste wood powder, sawdust, pulp, chaff powder, rice-straw powder, and various vegetable powders such as stalk or leaves of a corn, according to kinds of building material.

Furthermore, mineral powder used as the side component is selected from the group consisting of stone powders, volcanic ashes, and light glass-fibers in which pearlite is foamed, according to physical properties, such as strength, fire retardant, non-inflammability, sound proofing property, insulating property, and abrasion resistance of the building material.

The present inventors have conducted repeated studies into a method of forming building materials consisting of mostly magnesium oxide, resulting in the finding that when an admixture, produced by mixing magnesium oxide powder with at least one of vegetable powder, vegetable fiber, mineral powder, and mineral fiber and water, is fed into a preheated mold assembly and pressed, physical properties of the admixture are rapidly changed. In other words, contrary to a conventional expectation, the magnesium oxide in the mold assembly is rapidly hardened by moisture heated at 100° C. under a pressure of 10 kg/cm² and acts as a strong adhesive on the vegetable or mineral powder, thereby the product has improved strength. At this time, the higher the pressure is, the denser the structure is.

Based on the finding that the wet magnesium oxide is pressed and rapidly hardened by heat and pressure to display a strong adhesive strength, the present inventors accomplished the method of forming building materials consisting of mostly magnesium oxide by changing physical properties of the building materials by applying heat and pressure.

In the present invention, a mixing ratio of the magnesium oxide as a main component and the at least one of vegetable powder, vegetable fiber, mineral powder, and mineral fiber as a side component depends on a performance and physical properties of the building material. Additionally, various additives may be selectively added to an admixture mostly comprising the magnesium oxide according to needed physical properties of the building material. For example, a waterproofing agent may be added to the admixture so as to improve a waterproofing property of the building material, and different additives may be added to the admixture according to various molding process such as a compression molding, an injection molding, and an extrusion molding so as to improve plasticity of the building material.

Meanwhile, according to a conventional method of forming building materials using magnesium oxide, chloride is used as a hardening agent, but the chloride has a property for absorbing moisture in the atmosphere, i. e. deliquescence, and so a surface of the building material produced according to the conventional method provides a sticky sense. According to the present invention, however, the above disadvantage of the conventional method is overcome by using the building material mostly comprising magnesium oxide without the hardening agent (chloride).

As described above, the method of forming building materials mostly comprising magnesium oxide is characterized in that the magnesium oxide is used as a main component, and fine vegetable powder such as sawdust or mineral powder such as volcanic dust is selectively added to the magnesium oxide.

According to the method of forming building materials mostly comprising magnesium oxide of the present invention, magnesium oxide is used as a main component of the building material. If a building material with a wood texture is required, vegetable powder such as sawdust is added to the magnesium oxide powder. On the other hand, when a building material mostly having non-inflammability, insulating and soundproofing properties, and a light weight is needed, mineral powder such as ore powder or volcanic ash is added to the magnesium oxide powder in conjunction with water in a proper mixing ratio.

Particularly, various material powders such as fibroid material may be added to the magnesium oxide to form the building material in addition to the vegetable powder or the mineral powder. Furthermore, a mixing ratio of the magnesium oxide, and the vegetable powder or the mineral powder is not specifically limited in the present invention because the mixing ratio is variably changed according to physical properties of the building material.

In other words, the mixing ratio of components and a kind of side components are set forth to illustrate, but are not to be construed to limit the present invention.

Furthermore, it is neither possible nor preferable that a heating temperature and a pressure ratio are restricted to a specified value in a method of forming building materials according to the present invention. For example, when products, such as doors, requiring a large-sized mold are molded, the admixture in the mold is prone to drying because it takes a relatively long time to fill the admixture in the mold, so the products are preferably molded at a low temperature. As for pressure, when an insulating plate or a soundproof panel is produced using lightweight porous volcanic ashes, it is preferable that they are produced under low pressure so as to prevent pores of volcanic ashes from collapsing.

Reference now should be made to the drawings, in which the same reference numerals are used throughout the different drawings to designate the same or similar components.

According to a first embodiment of the present invention, 20 wt % sawdust and 30 wt % water are added to 50 wt % magnesium oxide powders to produce an admixture. The admixture is fed into a traditional compression mold assembly consisting of an upper mold and a lower mold, maintained at 100° C. under 10 kg/cm² for 2 to 5 min, and removed from the compression mold assembly. The resulting product has a smooth surface and high strength, like a plank.

According to a second embodiment of the present invention, the present inventor molds an admixture having the same composition as example 1 through a molding machine M manufactured by the present inventor.

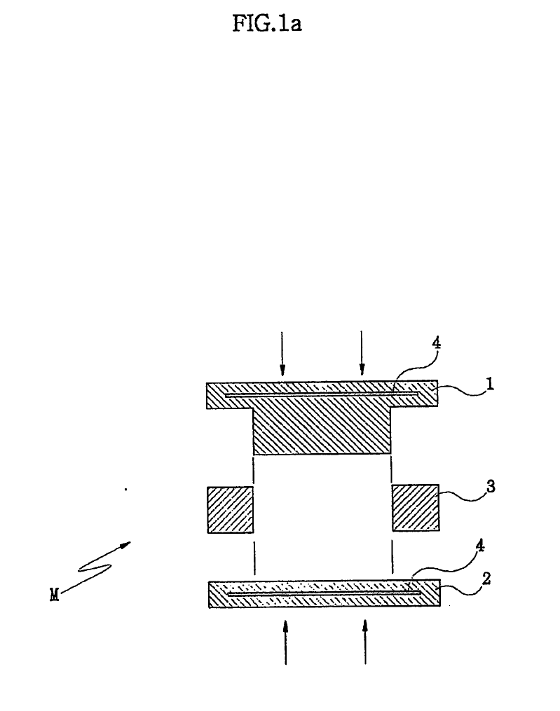

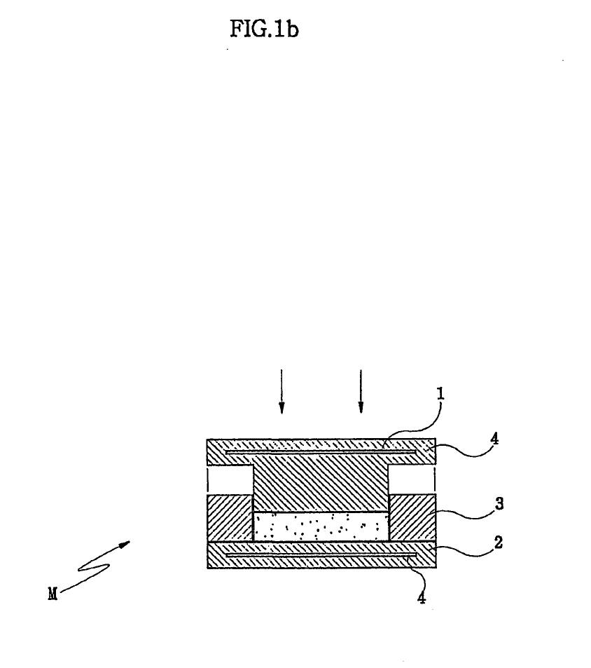

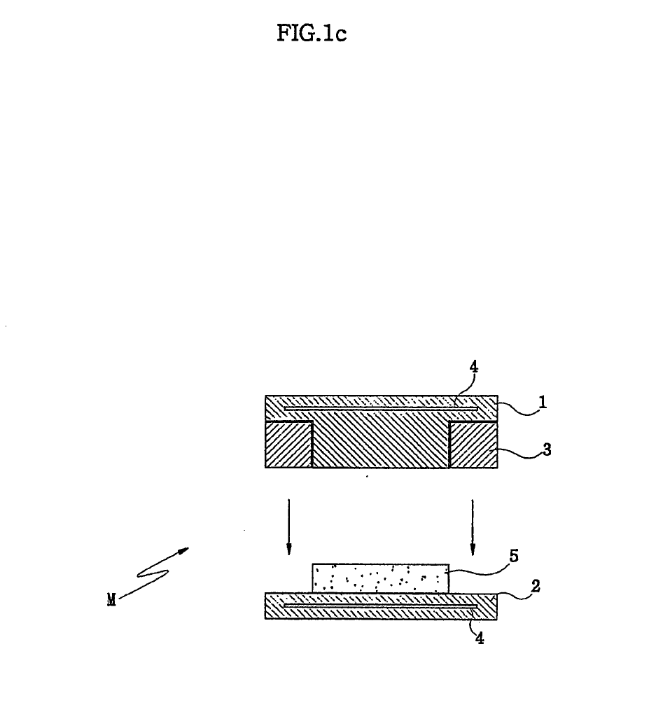

With reference to FIG. 1a, the molding machine M of the present invention comprises an upper mold 1, a frame mold 3, and a lower mold 2. The upper mold 1 is positioned at an upper portion of a press, which vertically moves, and the hollow frame mold 3, fixed at a middle portion of the press, has the same sectional shape as a section of a product. That is to say, when the product has a rectangular section, the frame mold 3 has also the hollow rectangular section, while when the product has a cylindrical section; the frame mold 3 has also the hollow cylindrical section.

In addition, a portion protruded from a lower side of the upper mold 1 has the same sectional shape as the hollow frame mold 3, and so the upper mold 1 acts as a piston. The lower mold 2 is positioned at a lower portion of the press, which moves vertically.

In FIGS. 1a to 1c, the molding machine M is illustrated on the assumption that a sectional shape of the product is cylindrical. As in FIG. 1b, the hollow cylindrical frame mold 3 is set on the lower mold 2 to form a concave frame mold assembly.

The admixture 5 of magnesium oxide with water and sawdust is fed into the concave frame mold assembly, pressed by the vertically moving upper mold 1 in such a way that the portion protruded from the upper mold 1 is inserted into the hollow frame mold 3, like a piston, and heated and hardened for 2 to 5 min by heaters 4 positioned in the upper mold 1 and the lower mold 2. After the admixture 5 in the frame mold 3 is hardened, the lower mold 2, in contact with a lower side of the frame mold 3, is separated from the frame mold 3 and the upper mold 1 inserted in the frame mold 3 is pressed further to remove the resulting product 5 from the frame mold 3. The resulting product has advantages of non-inflammability, a smooth surface, and a high strength.

The above product with excellent physical properties may be identically obtained using another type of molding machine M in which the lower mold 2 is fixed and the frame mold 3 moves vertically.

According to a third embodiment of the present invention, provided is a method of forming building materials mostly consisting of magnesium oxide, comprising the steps of mixing magnesium oxide powder with at least one of vegetable powder, vegetable fiber, mineral powder, and mineral fiber to produce an admixture; adding water to the admixture in such an amount that the admixture can be used in an injection molding to produce a wet admixture such as mortar; inserting the wet admixture from a nozzle through an inlet of a mold assembly into the mold assembly; hardening such admixture by a heater positioned in each mold; and releasing a resulting product from the mold assembly.

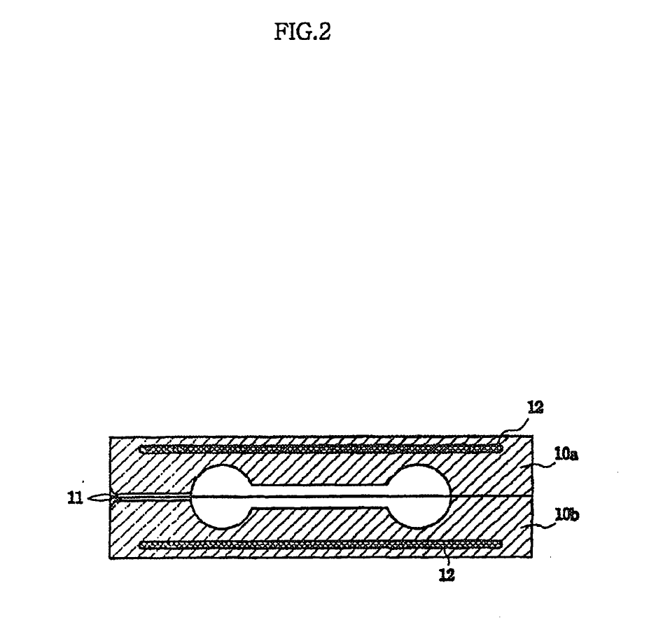

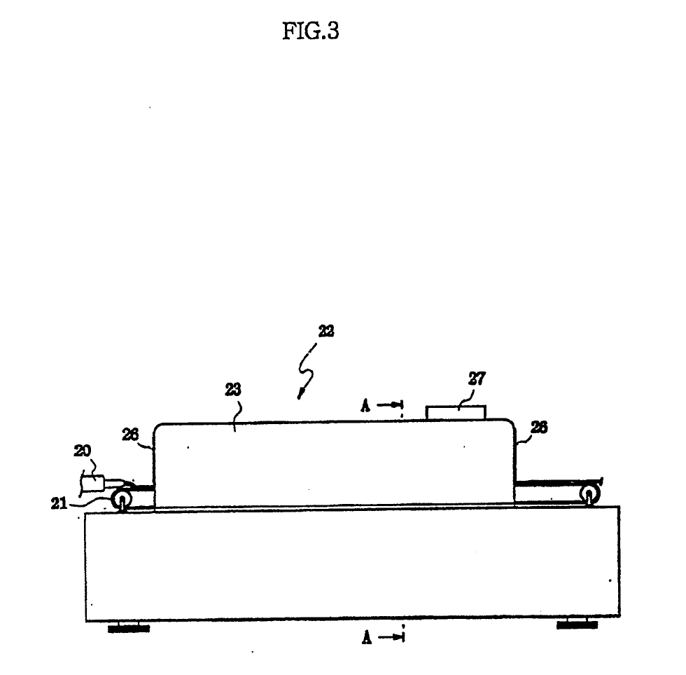

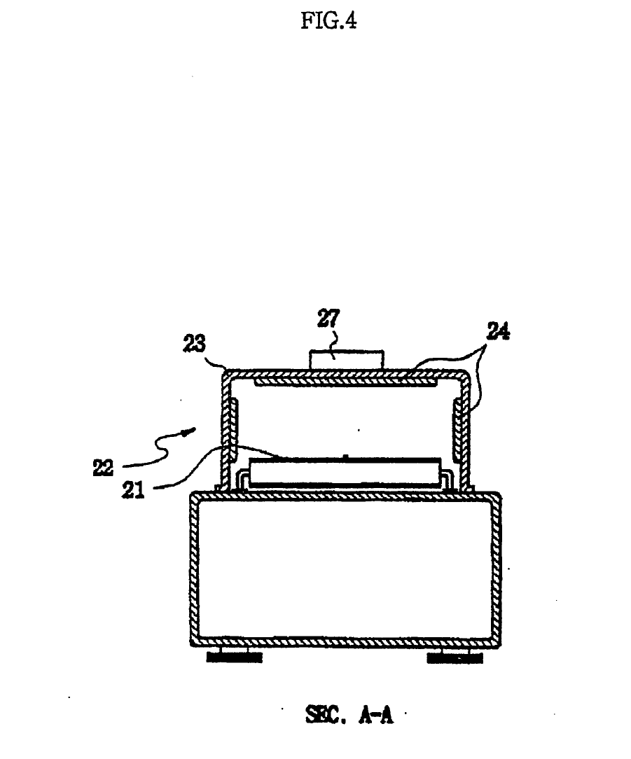

The admixture is hardened by a heater positioned in an injection mold during an insertion of the admixture into the mold assembly or after the admixture is inserted into the mold assembly, and removed from the mold assembly. In this case, the admixture is heat hardened in the mold having a heater, contrary to a traditional thermoplastic injection molding in which the plastic is cooled in an injection mold. In addition, when a product is formed with the use of an injector, the heater 12 is positioned in a mold for injecting a magnesium oxide admixture, as shown in FIG. 2.

Furthermore, an injection mold assembly comprises an upper and a lower mold 10a and 10b so as to realize a bilateral molding, and an inlet 11 positioned at one side thereof. The admixture is fed from a nozzle through the inlet 11 to the injection mold assembly. Additionally, the upper and lower mold 10a and 10b each have a heater 12 therein.

In the third embodiment, the heaters 12 positioned in the upper and lower mold 10a and 10b preheat the upper and lower mold 10a and 10b to a predetermined temperature before the admixture is fed into the mold assembly, the admixture is then fed through the inlet 11 by a high pressure pump positioned at an end of the nozzle to the mold assembly. At this time, it is preferable that the end of the nozzle is separated from the inlet 11 as soon as a feed of the admixture into the mold assembly is completed and until the admixture begins to be fed into the mold assembly in order to prevent the nozzle from clogging due to a hardening of the admixture by a heat transferred to the end of the nozzle. The heat rapidly hardens the admixture fed into the mold assembly, and so the resulting product is formed in a short period.

According to a fourth embodiment of the present invention, provided is a method of forming building materials mostly consisting of magnesium oxide, comprising the steps of mixing magnesium oxide powder with at least one of vegetable powder, vegetable fiber, mineral powder, and mineral fiber to produce an admixture; selectively adding water to the admixture in such an amount that the admixture can be used in an extrusion molding to produce a wet admixture such as mortar; extruding the wet admixture into a desired shape of a product by use of an extruder; and passing a resulting product through a heating device positioned before an outlet of the extruder by use of a blower to harden the resulting product.

In the extrusion process according to the present invention, it is important that sawdust or vegetable powder and water are mixed with magnesium oxide to produce an admixture in a state suitable for extrusion of the admixture. The admixture thus produced is extruded through a traditional extruder.

Particularly, a heating device 22 is positioned right before an outlet of an extruding device, and an extruded product is transferred to the heating device 22 and rapidly hardened by the heating device 22, and so the product is rapidly produced.

According to the fourth embodiment, the resulting product has a smooth surface and a dense structure because it is subjected to a high pressure during the extrusion process, and so it has a good appearance and is applied to a complicated shape of building material requiring a highly precise configuration.

The heating device 22 comprises a tunnel-type box 23 and a plurality of heaters 24. The heaters 24 are each controlled by a temperature controller (not shown) and separately positioned from each other in the tunnel-type box 23, and so a temperature in the tunnel-type box may be differently distributed. Particularly, the heating device 22 has a sufficiently long length so that the admixture is sufficiently heated to be desirably hardened. Further, it is preferable that a heat-shielding curtain 26 is positioned at openings of the heating device 22 so as to prevent heat from being emitted to atmosphere. Furthermore, a blower 27 is positioned at an end of the tunnel-type box 23 so as to emit moisture and gases occurring in passing of the admixture.

The extruded admixture is transferred through a conveyer belt 21 to the tunnel-type heating device 22, and rapidly hardened in the heating device 22 by a heat sufficiently provided for desirably hardening the admixture. At this time, heaters 24 separated from each other are properly controlled so as to rapidly harden the admixture as soon as possible under an optimum condition.

The resulting building material produced through the above procedure is noninflammable and has a smooth surface.

As described above, the, present invention provides a novel method of forming building materials mostly consisting of magnesium oxide, which makes the best use of merits of magnesium oxide. Therefore, the present invention has advantages as follows.

The method of forming building materials mostly consisting of magnesium oxide according to the present invention contributes to reducing casualties of fires. Conventional building materials mostly including plastics and adhesive resins are major factors causing people to die from suffocation due to poisonous gases generated during fire. The present invention has been made keeping in mind the above disadvantages occurring in the prior art, and a primary object of the present invention is to provide a method of forming building materials comprising nonflammable magnesium oxide powder and nontoxic vegetable powder. At this time, such building materials are nonflammable and do not emit toxic gas, thus contributing to saving many people.

Another advantage of the method according to the present invention is that the building materials are rapidly produced because heat rapidly hardens the admixture during a compression molding, an extrusion molding, or an injection molding. Additionally, the present invention has advantages of improved productivity and reduced labor because a transporting and a stacking process for hardening the admixture can be omitted and the time needed to sufficiently harden the admixture becomes short owing to a rapid hardening of the admixture, unlike a conventional method of forming a concrete.

Further, the present invention has an advantage of economic efficiency. In detail, abundant nontoxic vegetable waste resources such as sawdust, chaff, and cornstalks are recycled, and it is not necessary to separately process vegetable waste resources. Moreover, it is easy to cut or nail the building material of the present invention, and forests are protected due to use of wood substitutes. Accordingly, the present invention reduces use of wood and reduces logging to contribute to protecting forests supplying clean water and fresh air.

Furthermore, according to the present invention, the admixture is fed into a concave frame mold structure and compressed by an upper mold in such a way that a portion protruded from the upper mold is inserted into a hollow frame mold, like a piston, and a lower mold is separated from the frame mold and the upper mold inserted in the frame mold is pressed further to remove the resulting product from the frame mold, and so the resulting product has a good appearance and is applied to a complicated shape of building materials requiring a highly precise configuration.

Furthermore, the method of the present invention has advantages of improved productivity and reduced labor because a transporting and a stacking process for hardening the admixture can be omitted and the time needed to sufficiently harden the admixture becomes short owing to a rapid hardening of the admixture.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A method of forming building materials mostly comprising magnesium oxide, comprising the steps of:
a) mixing magnesium oxide powder with at least one of vegetable powder, vegetable fiber, mineral powder, and mineral fiber in a predetermined mixing ratio to produce an admixture;
b) adding water to the admixture to produce a wet powdered admixture;
c) inserting the wet powdered admixture into a preheated mold, and heating and simultaneously compressing the wet powdered admixture at 80° to 120° C. under a pressure of 10 to 250 kg/cm² to rapidly harden the admixture; and
d) releasing a resulting product from the mold.

2. A method of forming building materials mostly comprising magnesium oxide, comprising the steps of:
a) mixing magnesium oxide powder with at least one of vegetable powder, vegetable fiber, mineral powder, and mineral fiber in a predetermined mixing ratio to produce an admixture;
b) adding water to the admixture to produce a wet powdered admixture;
c) inserting the wet powdered admixture into a frame mold assembly of a molding machine including a frame mold and a preheated lower mold, and heating and simultaneously compressing the wet powdered admixture at 80° to 120° C. under a pressure of 10 to 250 kg/cm² after a lower side of an upper mold is inserted into the frame mold to rapidly harden the admixture; and
d) releasing a resulting product from the molding machine.

3. A method of forming building materials mostly comprising magnesium oxide, comprising the steps of:
a) mixing magnesium oxide powder with at least one of vegetable powder, vegetable fiber, mineral powder, and mineral fiber in a predetermined mixing ratio to produce an admixture;
b) adding water to the admixture in such an amount that the admixture is useful to be used in an injection molding to produce a wet admixture;
c) inserting the wet admixture from a high pressure nozzle through an inlet of a mold assembly into the mold assembly;
d) hardening the wet admixture by a heater positioned in each mold during insertion of the admixture into the mold assembly or after the admixture is inserted into the mold assembly; and
e) releasing a resulting product from the mold assembly.

4. A method of forming building materials mostly comprising magnesium oxide, comprising the steps of:
a) mixing magnesium oxide powder with at least one of vegetable powder, vegetable fiber, mineral powder, and mineral fiber in a predetermined mixing ratio to produce an admixture;
b) adding water to the admixture in such an amount that the admixture is useful to be used in an extrusion molding to produce a wet admixture;
c) extruding the wet admixture into a desired shape of a product by use of an extruder; and
d) passing a resulting product through a heating device positioned before an outlet of the extruder to harden the resulting product.

5. A building material mostly comprising magnesium oxide obtained by a method comprising the steps of:
a) mixing magnesium oxide powder with at least one of vegetable powder, vegetable fiber, mineral powder, and mineral fiber in a predetermined mixing ratio to produce an admixture;
b) adding water to the admixture to produce a wet powdered admixture;
c) inserting the wet powdered admixture into a preheated mold, and heating and simultaneously compressing the wet powdered admixture to rapidly harden the admixture; and
d) releasing a resulting product from the mold.
